(19) United States
(12) Patent Application Publication
(10) Pub. No.: US 2026/0269611 A1
(43) Pub. Date: Sep. 10, 2026

(54) POWER MANAGEMENT DEVICE AND POWER MANAGEMENT METHOD

(71) Applicant: Wiwynn Corporation, New Taipei City (TW)

(72) Inventors: Yu-Chun Chen, New Taipei City (TW); Ching-Yao Lien, New Taipei City (TW); Ming-Wei Lai, New Taipei City (TW); Chuan-Zhou Hung, New Taipei City (TW)

(73) Assignee: Wiwynn Corporation, New Taipei City (TW)

(21) Appl. No.: 19/280,140

(22) Filed: Jul. 25, 2025

(30) Foreign Application Priority Data
Mar. 6, 2025 (TW) 114108388

(51) Int. Cl. H02J 3/00

(52) U.S. Cl. CPC H02J 3/001

(57) ABSTRACT

A power management device includes a plurality of controllers and a power detection signal generator. The plurality of controllers respectively generate a plurality of power state signals. The power detection signal generator is coupled to the controllers, receives the power state signals, and generates a detection result signal according to the power state signals. The detection result signal has an oscillation frequency. The power detection signal generator sets the oscillation frequency of the detection result signal according to the power state signals.

### CROSS-REFERENCE TO RELATED APPLICATION

This application claims the priority benefit of Taiwan application serial no. 114108388, filed on Mar. 6, 2025. The entirety of the above-mentioned patent application is hereby incorporated by reference herein and made a part of this specification.

### BACKGROUND OF THE INVENTION

### Field of the Invention

The invention relates to a power management device and a power management method, and in particular to a power management device and a power management method for a server.

### Description of Related Art

In conventional servers, it is necessary to monitor the power states of a plurality of hot-swap controllers by detecting a plurality of power state signals, such as a power good signal. Therefore, a connector having a plurality of pins and a plurality of wires are needed to transmit the power state signals to the determination circuit. The power state of each hot-swap controller is determined via the determination circuit. This approach increases the production cost of the server and reduces the working efficiency of the server.

### SUMMARY OF THE INVENTION

The invention provides a power management device and a power management method that may effectively manage the power state of a server.

A power management device of the invention includes a plurality of controllers and a power detection signal generator. The plurality of controllers respectively generate a plurality of power state signals. The power detection signal generator is coupled to the controllers, receives the power state signals, and generates a detection result signal according to the power state signals. The detection result signal has an oscillation frequency. The power detection signal generator sets the oscillation frequency of the detection result signal according to the power state signals.

A power management method of the invention includes: generating a plurality of power state signals via a plurality of controllers respectively; generating a detection result signal in response to the power state signals via a power detection signal generator; and adjusting an oscillation frequency of the detection result signal according to the power state signals via the power detection signal generator.

Based on the above, in the power management device and the power management method of the invention, the power detection signal generator is provided to adjust the oscillation frequency of the detection result signal according to the power state signals of the controllers. Furthermore, the power management device may determine the power states of the plurality of controllers in the server according to the oscillation frequency of the detection result signal of a single signal to reduce the number of pins and wiring space needed between the circuit boards of the server, thereby effectively reducing the manufacturing cost of the server and improving the working performance of the server.

### BRIEF DESCRIPTION OF THE DRAWINGS

FIG. 1 shows a schematic diagram of a power management device according to an embodiment of the invention.

FIG. 2 shows a circuit diagram of a power detection signal generator according to an embodiment of the invention.

FIG. 3 shows a schematic diagram of a server according to an embodiment of the invention.

FIG. 4 shows a flowchart of a power management method according to an embodiment of the invention.

FIG. 5 shows a flowchart of a power management method according to an embodiment of the invention.

### DESCRIPTION OF THE EMBODIMENTS

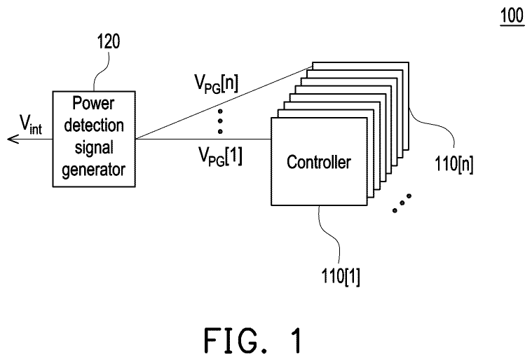

Referring to FIG. 1, FIG. 1 shows a schematic diagram of a power management device 100 to an embodiment of the invention. As shown in FIG. 1, the power management device 100 includes a plurality of controllers 110[1] to 110[n] and a power detection signal generator 120. In particular, in the present embodiment, the number of controllers 110[1] to 110[n] may be n, and n is a positive integer greater than 1. The controllers 110[1] to 110[n] may generate a plurality of power state signals V_{PG}[1] to V_{PG}[n] respectively according to the respective power states thereof. In detail, taking the controller 110[1] as an example, the controller 110[1] may generate a corresponding power state signal V_{PG}[1] according to whether the power voltage received by the controller 110[1] rises to a stable voltage value. For example, when the power voltage received by the controller 110[1] rises to a stable voltage value, the controller 110[1] may generate the power state signal V_{PG}[1] of a first logic value; conversely, when the power voltage received by the controller 110[1] does not rise to a stable voltage value, the controller 110[1] may generate the power state signal V_{PG}[1] of a second logic value. In particular, the first logic value is different from the second logic value. In an embodiment of the invention, the controllers 110[1] to 110[n] may all be hot-swap controllers.

In addition, the power detection signal generator 120 is coupled to the controllers 110[1] to 110[n]. The power detection signal generator 120 receives the power state signals V_{PG}[1] to V_{PG}[n] and generates a detection result signal Vᵢₙₜ according to the power state signals V_{PG}[1] to V_{PG}[n]. In detail, the power detection signal generator 120 may generate the detection result signal Vᵢₙₜ, and the power detection signal generator 120 may set the oscillation frequency of the detection result signal Vᵢₙₜ according to the power state signals V_{PG}[1] to V_{PG}[n]. For example, the power detection signal generator 120 may set the oscillation frequency of the corresponding detection result signal Vᵢₙₜ according to various combinations of the plurality of logic values of the power state signals V_{PG}[1] to V_{PG}[n]. Taking the number of the power state signals V_{PG}[1] to V_{PG}[n] as n as an example, the power detection signal generator 120 may correspond to various combinations of logic value states of the power state signals V_{PG}[1] to V_{PG}[n], so that the detection result signal Vᵢₙₜ may have 2″ different oscillation frequencies.

According to the above, by detecting the oscillation frequency of the detection result signal Vᵢₙₜ, the logic value of each of the power state signals V_{PG}[1] to V_{PG}[n] correspondingly generated by each of the corresponding controllers 110[1] to 110[n] may be known, and whether the power state of each of the controllers 110[1] to 110[n] is normal may also be known. It is worth mentioning that the detection result signal Vᵢₙₜ is a single-bit signal and may be transmitted via only a single pin and a single wire. Therefore, by disposing the power detection signal generator 120 of the invention in an electronic device (such as a server), the number of pins and wiring space needed by the electronic device may be reduced to lower the manufacturing cost of the server and improve the working performance of the server.

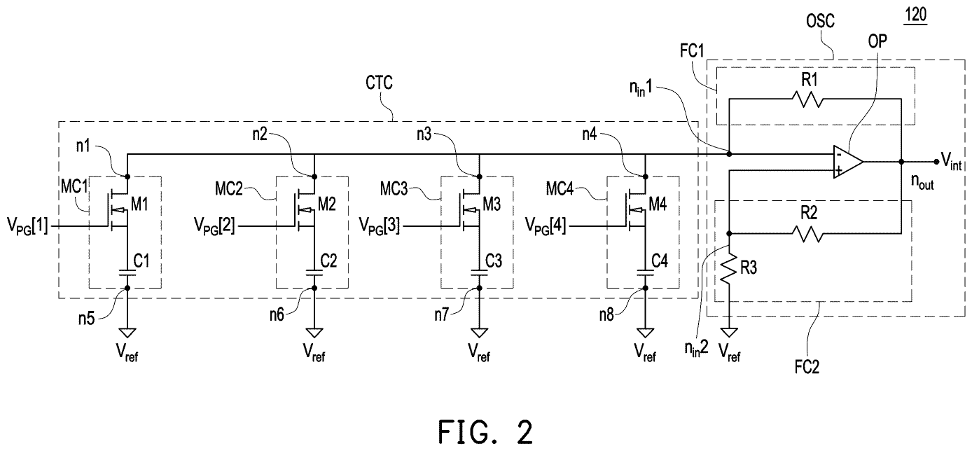

Referring to FIG. 2, FIG. 2 shows a circuit diagram of the power detection signal generator 120 according to an embodiment of the invention. In the present embodiment, the power detection signal generator 120 may be implemented by the circuit shown in FIG. 2. As shown in FIG. 2, the power detection signal generator 120 includes an oscillation circuit OSC and a variable capacitance circuit CTC. In particular, the oscillation circuit OSC is used to generate the detection result signal Vᵢₙₜ. The variable capacitance circuit CTC is coupled to the oscillation circuit OSC, receives power state signals V_{PG}[1], V_{PG}[2], V_{PG}[3], and V_{PG}[4], and adjusts the provided equivalent capacitance values according to the power state signals V_{PG}[1], V_{PG}[2], V_{PG}[3], and V_{PG}[4]. It should be understood that in the present embodiment, the number of controllers (=4) is only an example for illustration, and in actual application, there is no particular limitation on the number of controllers.

In detail, the variable capacitance circuit CTC includes a plurality of capacitors C₁ to C₄ and a plurality of switches M1 to M4. The switches M1 to M4 are respectively connected in series with the capacitors C₁ to C₄ to form a plurality of capacitor-switch strings MC1 to MC4. A terminal n1 of the capacitor-switch string MC1, a terminal n2 of the capacitor-switch string MC2, a terminal n3 of the capacitor-switch string MC3, and a terminal n4 of the capacitor-switch string MC4 are mutually coupled to the oscillation circuit OSC. A terminal n5 of the capacitor-switch string MC1, a terminal n6 of the capacitor-switch string MC2, a terminal n7 of the capacitor-switch string MC3, and a terminal n8 of the capacitor-switch string MC4 may all receive a reference voltage Vref. In the present embodiment, the reference voltage Vref may be a ground voltage (i.e., 0 V).

In addition, the switches M1 to M4 are controlled by the power state signals V_{PG}[1], V_{PG}[2], V_{PG}[3], and V_{PG}[4], respectively. In other words, the switches M1 to M4 are turned on or off according to the power state signals V_{PG}[1], V_{PG}[2], V_{PG}[3], and V_{PG}[4], respectively. When the switch M1 is changed from being turned off to being turned on, the path of the capacitor C1 coupled to the oscillation circuit OSC may be turned on, and a capacitance value CT provided by the variable capacitance circuit CTC may be increased; conversely, when the switch M1 is changed from being turned on to being turned off, the path of the capacitor C1 coupled to the oscillation circuit OSC may be turned off, and the capacitance value CT provided by the variable capacitance circuit CTC may be reduced. The same is true for the switches M2 to M4. That is, when the switch M2, M3, or M4 is changed from being turned off to being turned on, the path of the capacitor C2, C3, or C4 coupled to the oscillation circuit OSC may be changed to be turned on, and the capacitance value CT provided by the variable capacitance circuit CTC may be increased; conversely, when the switch M2, M3, or M4 is changed from being turned on to being turned off, the path of the capacitor C2, C3, or C4 coupled to the oscillation circuit OSC may be changed to be turned off, and the capacitance value CT provided by the variable capacitance circuit CTC may be reduced. Therefore, the capacitance value Cr provided by the variable capacitance circuit CTC may be adjusted by switching the switches M2 to M4 via the power state signals V_{PG}[1], V_{PG}[2], V_{PG}[3], and V_{PG}[4].

In addition, in the present embodiment, the switches M1 to M4 may be transistor switches. Accordingly, the power state signals V_{PG}[1], V_{PG}[2], V_{PG}[3], and V_{PG}[4] may be voltage signals and are provided to the control terminals of the switches M1 to M4, respectively, so that the switches M1 to M4 are turned on or off. In the present embodiment, the voltage of each of the power state signals V_{PG}[1], V_{PG}[2], V_{PG}[3], or V_{PG}[4] may be equal to a high voltage level or a low voltage level. Under this configuration, each of the power state signals V_{PG}[1], V_{PG}[2], V_{PG}[3], or V_{PG}[4] may optionally correspond to a logic value of 0 or 1, wherein the logic values 0 and 1 may indicate an abnormal power state and a normal power state, respectively. Alternatively, in other embodiments of the invention, the logic values 1 and 0 may respectively indicate an abnormal power state and a normal power state, without any particular limitation.

In addition, it is worth noting that in the present embodiment, a capacitance value Cv1 of the capacitor C1, a capacitance value Cv2 of the capacitor C2, a capacitance value Cv3 of the capacitor C3, and a capacitance value Cv4 of the capacitor C4 may be different from each other, for example: {Cv1, Cv2, Cv3, Cv4}={1 pF, 4 pF, 8 pF, 16 pF} and {Cv1, Cv2, Cv3, Cv4}={0.1 pF, 1 pF, 4 pF, 8 pF}, wherein pF is picofarad. It is worth noting that the capacitance values Cv1 to Cv4 may be set according to actual needs without any particular limitation. In this way, via the above various implementations, the variable capacitance circuit CTC may provide a suitable capacitance value Cr to generate an oscillation frequency of the oscillation circuit OSC that may distinguish different power states.

Moreover, the oscillation circuit OSC adjusts the oscillation frequency of the detection result signal Vᵢₙₜ according to the capacitance value CT provided by the variable capacitance circuit CTC. In the present embodiment, the capacitance value CT provided by the variable capacitance circuit CTC may be used to adjust the transmission delay of the internal signal of the oscillation circuit OSC, and further adjust the oscillation frequency of the detection result signal Vᵢₙₜ. When the capacitance value CT provided by the variable capacitance circuit CTC is increased, the oscillation frequency of the detection result signal Vᵢₙₜ is correspondingly reduced; conversely, when the capacitance value CT provided by the variable capacitance circuit CTC is decreased, the oscillation frequency of the detection result signal Vᵢₙₜ is correspondingly increased.

The oscillation circuit OSC may include an operational amplifier OP, a feedback circuit FC1, and a feedback circuit FC2. As shown in FIG. 2, the operational amplifier OP has a negative input terminal nᵢₙ1. The negative input terminal nᵢₙ1 is coupled to the variable capacitance circuit CTC. The feedback circuit FC1 is coupled between an output terminal nₒᵤₜ of the operational amplifier OP and the negative input terminal nᵢₙ1 of the operational amplifier OP. The feedback circuit FC2 is coupled between the output terminal nₒᵤₜ of the operational amplifier OP and a positive input terminal nin2 of the operational amplifier OP.

In the present embodiment, the feedback circuit FC1 may include a resistor R1. One terminal of the resistor R1 is coupled to the output terminal nₒᵤₜ of the operational amplifier OP. Another terminal of the resistor R1 is coupled to the negative input terminal nᵢₙ 1 of the operational amplifier OP. In the present embodiment, the feedback circuit FC2 may include a resistor R2 and a resistor R3. One terminal of the resistor R2 is coupled to the output terminal nₒᵤₜ of the operational amplifier OP. Another terminal of the resistor R2 is coupled to the positive input terminal nᵢₙ2 of the operational amplifier OP. A terminal of the resistor R3 is coupled to the positive input terminal nᵢₙ2 of the operational amplifier OP. Another terminal of the resistor R3 is coupled to the reference voltage V_{ref}. Under the above configuration, an oscillation frequency F may be calculated according to equation (1) as follows:

$$1 / F = 2 Rv 1 \times CT \times ln ( 1 + 2 Rv 3 / Rv 2 ) , \qquad equation ( 1 )$$

wherein Rv1, Rv2, and Rv3 are the resistance values of the resistor R1, the resistance value of the resistor R2, and the resistance value of the resistor R3, respectively. In the present embodiment, the resistance value Rv2 may be the same as the resistance value Rv3, for example, Rv1=Rv2=10 kilo-ohms (kΩ). In this way, the period (the inverse of the oscillation frequency F, 1/F) may be proportional to Rv1×CT. It is worth noting that the resistance values of the resistors R1 to R3 may be set according to actual needs without any particular limitation. In addition, for the circuit shown in FIG. 2, the capacitance value CT provided by the variable capacitance circuit CTC is:

$$CT = {\sum }_{j = jc} Cvj , \qquad equation ( 2 )$$

wherein Cvjc is the equivalent capacitance value of the capacitor-switch string when the switch is turned on. For example, if the switches M1 and M4 are turned on and the switches M2 and M3 are turned off, CT=Cv1+Cv2.

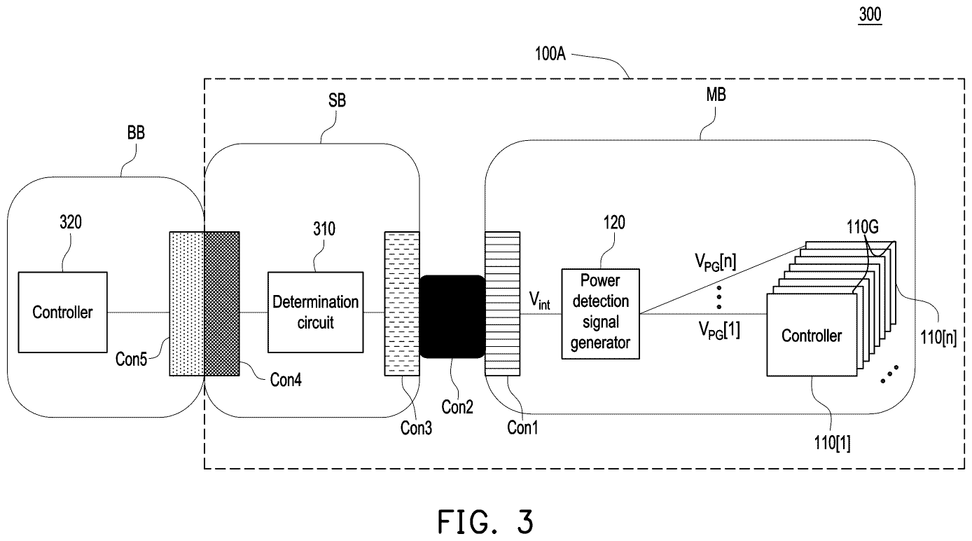

Please refer to FIG. 1 and FIG. 3, wherein FIG. 3 shows a schematic diagram of a server 300 according to an embodiment of the invention. In the present embodiment, the power management device may further include a determination circuit 310 as shown in FIG. 3. Specifically, the power management device 100 of FIG. 1 is further coupled to the determination circuit 310 via the power detection signal generator 120 to form a power management device 100A in FIG. 3. In addition, the determination circuit 310 is coupled to the power detection signal generator 120, receives the detection result signal Vᵢₙₜ, and determines the power state of each of the controllers 110[1], 110[2], . . . or 110[n] according to the oscillation frequency of the detection result signal Vᵢₙₜ. In the present embodiment, the determination circuit 310 and the power detection signal generator 120 may be coupled via connectors Con1 to Con3. In detail, the connector Con1 includes at least one pin to transmit the detection result signal Vᵢₙₜ to the connector Con2; the connector Con2 may be a transmission line; and the connector Con3 may be a connection port. In addition, in the present embodiment, the determination circuit 310 may be a complex programmable logic device (CPLD).

In the present embodiment, the determination circuit 310 may include a lookup table. The lookup table records the relationship between the oscillation frequency of the detection result signal Vᵢₙₜ and the logic values of the power state signals V_{PG}[1] to V_{PG}[n]. The relationship between the oscillation frequency and the power state signals V_{PG}[1] to V_{PG}[n] is changed with the capacitance values Cv1 to Cvn and the resistance values Rv1 to Rv3. The following explanations are all based on n=4, Rv1=25 kΩ2, and Rv2=Rv3.

When {Cv1, Cv2, Cv3, Cv4}={1 pf, 4 pf, 8 pf, 16 pf}, the lookup table is shown in Table 1, wherein the oscillation frequency is in Hertz (Hz):

TABLE 1

| | | | | Oscillation | |
|---|---|---|---|---|---|
| V_{PG}[1] | V_{PG}[2] | V_{PG}[3] | V_{PG}[4] | frequency | |
| 0 | 0 | 0 | 0 | 0 | |
| 0 | 0 | 0 | 1 | 1138 | Hz |
| 0 | 0 | 1 | 0 | 2276 | Hz |
| 0 | 0 | 1 | 1 | 759 | Hz |
| 0 | 1 | 0 | 0 | 4551 | Hz |
| 0 | 1 | 0 | 1 | 910 | Hz |
| 0 | 1 | 1 | 0 | 1517 | Hz |
| 0 | 1 | 1 | 1 | 650 | Hz |
| 1 | 0 | 0 | 0 | 18205 | Hz |
| 1 | 0 | 0 | 1 | 1071 | Hz |
| 1 | 0 | 1 | 0 | 2023 | Hz |
| 1 | 0 | 1 | 1 | 728 | Hz |
| 1 | 1 | 0 | 0 | 3641 | Hz |
| 1 | 1 | 0 | 1 | 867 | Hz |
| 1 | 1 | 1 | 0 | 1400 | Hz |
| 1 | 1 | 1 | 1 | 62 8 | Hz |

When {Cv1, Cv2, Cv3, Cv4}={0.1 pf, 1 pf, 4 pf, 8 pf}, the lookup table is shown in Table 2, wherein the oscillation frequency is in Hertz (Hz):

TABLE 2

| | | | | Oscillation | |
|---|---|---|---|---|---|
| V_{PG}[1] | V_{PG}[2] | V_{PG}[3] | V_{PG}[4] | frequency | |
| 0 | 0 | 0 | 0 | 0 | |
| 0 | 0 | 0 | 1 | 2276 | Hz |
| 0 | 0 | 1 | 0 | 4551 | Hz |
| 0 | 0 | 1 | 1 | 1517 | Hz |
| 0 | 1 | 0 | 0 | 18205 | Hz |
| 0 | 1 | 0 | 1 | 2100 | Hz |
| 0 | 1 | 1 | 0 | 3641 | Hz |
| 0 | 1 | 1 | 1 | 1400 | Hz |
| 1 | 0 | 0 | 0 | 182048 | Hz |
| 1 | 0 | 0 | 1 | 2348 | Hz |
| 1 | 0 | 1 | 0 | 4440 | Hz |
| 1 | 0 | 1 | 1 | 1505 | Hz |
| 1 | 1 | 0 | 0 | 16550 | Hz |
| 1 | 1 | 0 | 1 | 2001 | Hz |
| 1 | 1 | 1 | 0 | 3570 | Hz |
| 1 | 1 | 1 | 1 | 1350 | Hz |

By comparing Table 1 with Table 2, it may be seen that when the difference between the capacitance values Cv1, Cv2, Cv3, and Cv4 is increased, the difference in the oscillation frequency corresponding to different sets of power state signals {V_{PG}[1], 10 V_{PG}[2], V_{PG}[3], and V_{PG}[4]} is increased.

The determination circuit 310 may look up the power state of each of the controllers 110[1], 110[2], . . . or 110[n] according to the oscillation frequency of the detection result signal Vᵢₙₜ based on the lookup table. For example, when {Cv1, Cv2, Cv3, Cv4}={1 pf, 4 pf, 8 pf, 16 pf}, if the oscillation frequency is 1071 Hz, based on Table 1, the determination circuit 310 looks up that the power states of the controllers 110[1] and 110[4] are normal and the power states of the controllers 110[2] and 110[3] are abnormal. For another example, when {Cv1, Cv2, Cv3, Cv4}={0.1 pf, 1 pf, 4 pf, 8 pf}, if the oscillation frequency is 1350 Hz, based on Table 2, the determination circuit 310 looks up that the power states of the controllers 110[1] to 110[4] are all normal.

In the present embodiment, the lookup table may be constructed using a memory element or circuit well known to those skilled in the art and may store data. Examples include various types of memory, registers, or electronic fuses, without any particular limitation.

When the power management device 100A monitors the power state of the server, the power management device 100A may be further coupled to a controller on a substrate of the server. Therefore, as shown in FIG. 3, the server 300 includes the power management device 100A and a controller 320. In detail, the controller 320 is coupled to the determination circuit 310 in the power management device 100A. In the present embodiment, the power management device 100A and the determination circuit 310 may be coupled to each other via connectors Con4 and Con5.

In addition, in the present embodiment, the controllers 110[1] to 110[n] and the power detection signal generator 120 may be disposed at a circuit board MB, such as a medusa board. In the present embodiment, the determination circuit 310 may be disposed on a circuit board SB, such as a spider board. In the present embodiment, the controller 320 may be disposed at a substrate BB, such as a server motherboard. In the present embodiment, the controller 320 may be a baseboard management controller (BMC).

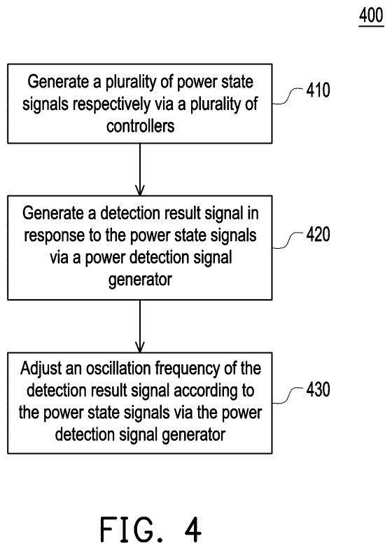

Please refer to FIG. 1, FIG. 3, and FIG. 4. FIG. 4 is a flowchart of a power management method 400 according to some embodiments of the invention. It should be understood that the power management method 400 is merely an illustrative example and, therefore, the steps described with respect to the power management method 400 may be reordered, added, or deleted while remaining within the scope of the disclosure.

In step 410, the plurality of power state signals V_{PG}[1] to V_{PG}[n] are respectively generated by the plurality of controllers 110[1] to 110[n]. In step 420, the power detection signal generator 120 generates the detection result signal Vᵢₙₜ in response to the power state signals V_{PG}[1] to V_{PG}[n]. Moreover, in step 430, the power detection signal generator 120 adjusts the oscillation frequency of the detection result signal Vᵢₙₜ according to the power state signals V_{PG}[1] to V_{PG}[n]. In detail, the power detection signal generator 120 adjusts the capacitance value CT of the variable capacitance circuit CTC according to the power state signals V_{PG}[1] to V_{PG}[n]. Furthermore, the power detection signal generator 120 adjusts the oscillation frequency of the detection result signal Vᵢₙₜ via the capacitance value CT of the variable capacitance circuit CTC.

Next, the determination circuit 310 determines the power state of each of the controllers 110[1], 110[2], . . . or 110[n] according to the oscillation frequency of the detection result signal Vᵢₙₜ. In detail, the determination circuit 310 may pre-record the relationship between the oscillation frequency of the detection result signal Vᵢₙₜ and the power state signals V_{PG}[1] to V_{PG}[n] to obtain a lookup table. Furthermore, the determination circuit 310 looks up the power state of each of the controllers 110[1], 110[2], . . . or 110[n] according to the oscillation frequency of the detection result signal Vᵢₙₜ based on the lookup table.

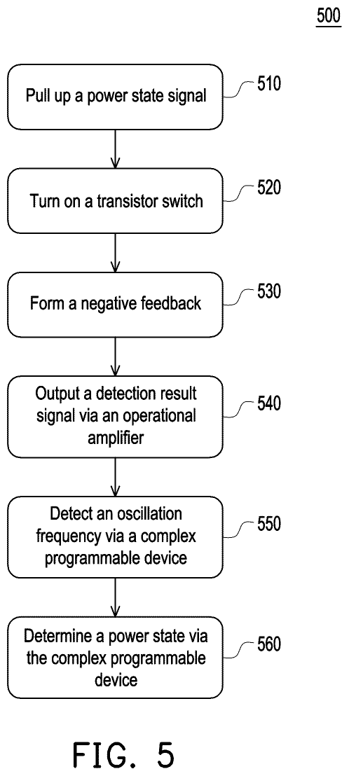

Please refer to FIG. 2 and FIG. 5 together. FIG. 5 shows a flowchart of a power management method 500 according to some embodiments of the invention. More specifically, when the power detection signal generator 120 is implemented by the circuit shown in FIG. 2, the power management devices 100 and 100A may be operated via the power management method 500, wherein the switches M1 to M4 may be constructed by N-type transistors. The determination circuit 310 may be a processor having computing capabilities, or may be a hardware circuit designed via a hardware description language (HDL) or any other digital circuit design method known to those skilled in the art and implemented via a field-programmable gate array (FPGA), a complex programmable logic device (CPLD), or an application-specific integrated circuit (ASIC). It should be understood that the power management method 500 is merely an illustrative example and, therefore, the steps described with respect to the power management method 500 may be reordered, added, or deleted while remaining within the scope of the disclosure.

In other embodiments of the invention, the switches M1 to M4 may also be constructed by P-type transistors. The transistors used to construct the switches M1 to M4 may be any type of transistors without any specific limitation.

In step 510, at least one of the controllers 110[1] to 110[n] pulls up at least one of the power state signals V_{PG}[1] to V_{PG}[n]. In other words, at least one of the power state signals V_{PG}[1] to V_{PG}[n] is made equal to a high voltage level. In step 520, in response to the at least one of the pull-up power state signals V_{PG}[1] to V_{PG}[n], a transistor switch receiving the at least one of the power state signals V_{PG}[1] to V_{PG}[n] is turned on. For example, when the power state signal V_{PG}[1] is pulled up, the transistor switch M1 is turned on.

In step 530, at least one input signal is transmitted to the negative input terminal nᵢₙ1 of the operational amplifier OP via the turned-on transistor switch. At least one input signal is then transmitted to the output terminal nₒᵤₜ of the operational amplifier OP via the feedback circuit FC1, thereby forming a negative feedback.

In step 540, the operational amplifier OP outputs the detection result signal Vᵢₙₜ at the output terminal nₒᵤₜ.

In step 550, the complex programmable device receives the detection result signal Vᵢₙₜ and detects the oscillation frequency of the detection result signal Vᵢₙₜ.

In step 560, the complex programmable device determines the power state of each of the controllers 110[1], 110[2], . . . or 110[n] according to the oscillation frequency of the detection result signal Vᵢₙₜ. It should be noted that since the complex programmable device is one of the examples of the determination circuit 310, the operation methods of the determination circuit 310 in the method 400 are all applicable to the complex programmable device and are not described again for simplicity.

Based on the above, the power management device and power management method of the invention determine the power states of the plurality of controllers via the oscillation frequency of the detection result signal of a single signal generated by the power detection signal generator to reduce the number of pins and wiring space needed, thereby reducing manufacturing costs and improving working efficiency.

What is claimed is:

1. A power management device, comprising:
a plurality of controllers respectively generating a plurality of power state signals; and
a power detection signal generator coupled to the controllers, receiving the power state signals, and generating a detection result signal according to the power state signals,
wherein the detection result signal has an oscillation frequency, and the power detection signal generator sets the oscillation frequency of the detection result signal according to the power state signals.

2. The power management device of claim 1, wherein the power detection signal generator comprises:
an oscillation circuit for generating the detection result signal;
a variable capacitance circuit coupled to the oscillation circuit and receiving the power state signals, and the variable capacitance circuit adjusts a capacitance value provided according to the power state signals,
wherein the oscillation circuit adjusts the oscillation frequency of the detection result signal according to the capacitance value provided by the variable capacitance circuit.

3. The power management device of claim 2, wherein the oscillation circuit comprises:
an operational amplifier having a negative input terminal coupled to the variable capacitance circuit;
a first feedback circuit coupled between an output terminal of the operational amplifier and a negative input terminal of the operational amplifier; and
a second feedback circuit coupled between an output terminal of the operational amplifier and a positive input terminal of the operational amplifier.

4. The power management device of claim 3, wherein the first feedback circuit comprises a first resistor, a first terminal of the first resistor is coupled to an output terminal of the operational amplifier, and a second terminal of the first resistor is coupled to a negative input terminal of the operational amplifier.

5. The power management device of claim 4, wherein the second feedback circuit comprises a second resistor and a third resistor, a first terminal of the second resistor is coupled to the output terminal of the operational amplifier, a second terminal of the second resistor is coupled to the positive input terminal of the operational amplifier, a first terminal of the third resistor is coupled to the positive input terminal of the operational amplifier, and a second terminal of the third resistor receives a reference voltage.

6. The power management device of claim 5, wherein a resistance value of the second resistor is the same as a resistance value of the third resistor.

7. The power management device of claim 2, wherein the variable capacitance circuit comprises:
a plurality of capacitors; and
a plurality of switches, wherein the switches are respectively connected in series with the capacitors to form a plurality of capacitor-switch strings, first terminals of the capacitor-switch strings are mutually coupled to the oscillation circuit, second terminals of the capacitor-switch strings are mutually coupled to a reference voltage, and the switches are respectively controlled by the power state signals.

8. The power management device of claim 7, wherein capacitance values of the capacitors are different from each other.

9. The power management device of claim 7, wherein each of the switches is a transistor switch, and the power state signals are voltage signals and respectively provided to control terminals of the switches.

10. The power management device of claim 9, wherein a voltage of each of the power state signals is equal to a first voltage level or a second voltage level, wherein the first voltage level is greater than a voltage threshold of a corresponding switch, and the second voltage level is less than the voltage threshold of the corresponding switch.

11. The power management device of claim 1, further comprising:
a determination circuit coupled to the power detection signal generator, receiving the detection result signal, and determining a power state of each of the controllers according to the oscillation frequency of the detection result signal.

12. The power management device of claim 11, wherein the determination circuit comprises a lookup table, and the lookup table records a relationship between the oscillation frequency of the detection result signal and the power state signals, wherein the determination circuit looks up a power state of each of the controllers according to the oscillation frequency of the detection result signal based on the lookup table.

13. The power management device of claim 11, wherein the controllers and the power detection signal generator are disposed on a first circuit board.

14. The power management device of claim 13, wherein the determination circuit is disposed on a second circuit board different from the first circuit board.

15. A power management method, comprising:
generating a plurality of power state signals via a plurality of controllers respectively;
generating a detection result signal in response to the power state signals via a power detection signal generator; and
adjusting an oscillation frequency of the detection result signal according to the power state signals via the power detection signal generator.

16. The power management method of claim 15, further comprising:
determining a power state of each of the controllers according to the oscillation frequency of the detection result signal via a determination circuit.

17. The power management method of claim 16, wherein the step of determining the power state of each of the controllers according to the oscillation frequency of the detection result signal via the determination circuit comprises:
recording a relationship between the oscillation frequency of the detection result signal and the power state signals to obtain a lookup table; and
looking up the power state of each of the controllers according to the oscillation frequency of the detection result signal based on the lookup table.

18. The power management method of claim 15, wherein the step of adjusting the oscillation frequency of the detection result signal according to the power state signals via the power detection signal generator comprises:
adjusting a capacitance value of a variable capacitance circuit according to the power state signals via the power detection signal generator; and
adjusting the oscillation frequency of the detection result signal according to the capacitance value of the variable capacitance circuit.
